(19) United States
(12) Patent Application Publication
(10) Pub. No.: US 2013/0334447 A1
(43) Pub. Date: Dec. 19, 2013

(54) Electric Expansion Valve

(71) Applicant: Eli Carlton Beard, Tyler, TX (US)

(72) Inventor: Eli Carlton Beard, Tyler, TX (US)

(73) Assignee: TRANE INTERNATIONAL INC., Piscataway, NJ (US)

(21) Appl. No.: 13/495,769

(22) Filed: Jun. 13, 2012

(51) Int. Cl. F16K 31/02; H01F 7/06

(52) U.S. Cl. 251/129.15; 29/606

(57) ABSTRACT

An HVAC system has an electronic expansion valve that has a valve body comprising a first motor component and a coil assembly comprising a plurality of stator bars, the plurality of stator bars being sealed from a surrounding environment by at least one fluid tight barrier at least partially disposed between the valve body and the plurality of stator bars.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Some heating, ventilation, and air conditioning (HVAC) systems may comprise an electronic expansion valve (EEV) and also be configured as a so-called heat pump.

### SUMMARY OF THE DISCLOSURE

In some embodiments of the disclosure, an HVAC system is disclosed as comprising an electronic expansion valve. In some embodiments, the electronic expansion valve comprises a valve body comprising a first motor component and a coil assembly comprising a plurality of stator bars, the plurality of stator bars being sealed from a surrounding environment by at least one fluid tight barrier at least partially disposed between the valve body and the plurality of stator bars.

In other embodiments of the disclosure, an electronically controlled expansion valve comprising a generally cylindrical valve body comprising a valve body central axis and a generally annular coil assembly comprising a coil assembly central axis, the coil assembly being configured to selectively receive at least a portion of the valve body though an aperture of the coil assembly when the valve body central axis and the coil assembly central axis are substantially coaxially aligned with each other, the coil assembly comprising a plurality of electromagnetic drivers that extend radially inward toward the valve body, and a fluid tight barrier at least partially disposed radially between the plurality of electromagnetic drivers and the valve body is disclosed.

In yet other embodiments of the disclosure, a method of constructing an electronically controlled expansion valve comprising providing a coil assembly comprising a plurality of stator bars and sealing the plurality of stator bars from a surrounding environment is disclosed.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is simplified schematic diagram of an HVAC system according to an embodiment of the disclosure;

FIG. 2 is a simplified schematic diagram of the air circulation paths of the HVAC system of FIG. 1;

Prior Art FIG. 3 is an oblique view of an EEV according to the disclosure;

Prior Art FIG. 4 is an oblique view of a coil assembly of the EEV of Prior Art FIG. 3;

Prior Art FIG. 5 is an oblique view of another embodiment of a coil assembly according to the disclosure;

FIG. 6 is an oblique view of a another embodiment of a coil assembly according to the disclosure; and

FIG. 7 is an oblique view of another embodiment of a coil assembly according to the disclosure.

### DETAILED DESCRIPTION

Some HVAC systems comprise EEVs having coil assemblies with exposed metal components. In some cases, the exposed metal components may oxidize. In some cases, the oxidized metal components may cause difficulty in servicing an HVAC system, may interfere with operation of an HVAC system, may decrease a lifespan of a component of the HVAC system, and/or may present an undesirable visual appearance of the products of the oxidation. Accordingly, in some embodiments, this disclosure provides systems and methods that prevent and/or reduce the above-described oxidation of EEV coil assemblies.

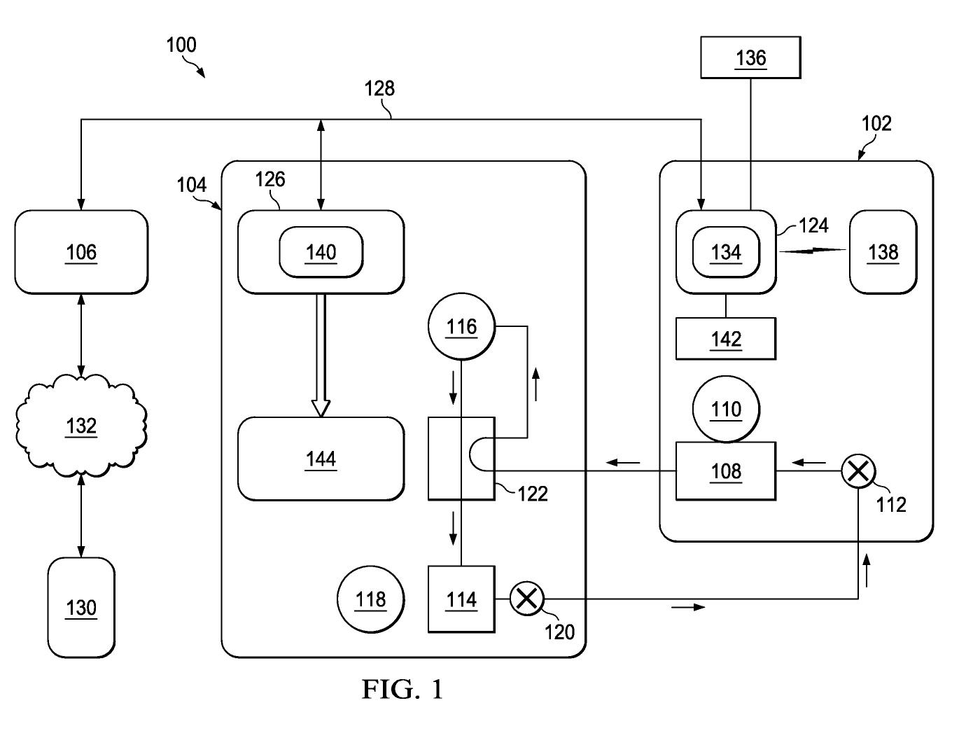

Referring now to FIG. 1, a simplified schematic diagram of an HVAC system 100 according to an embodiment of this disclosure is shown. HVAC system 100 comprises an indoor unit 102, an outdoor unit 104, and a system controller 106. In some embodiments, the system controller 106 may operate to control operation of the indoor unit 102 and/or the outdoor unit 104. As shown, the HVAC system 100 is a so-called heat pump system that may be selectively operated to implement one or more substantially closed thermodynamic refrigeration cycles to provide a cooling functionality and/or a heating functionality.

Indoor unit 102 comprises an indoor heat exchanger 108, an indoor fan 110, and an indoor metering device 112. Indoor heat exchanger 108 is a plate fin heat exchanger configured to allow heat exchange between refrigerant carried within internal tubing of the indoor heat exchanger 108 and fluids that contact the indoor heat exchanger 108 but that are kept segregated from the refrigerant. In other embodiments, indoor heat exchanger 108 may comprise a spine fin heat exchanger, a microchannel heat exchanger, or any other suitable type of heat exchanger.

The indoor fan 110 is a centrifugal blower comprising a blower housing, a blower impeller at least partially disposed within the blower housing, and a blower motor configured to selectively rotate the blower impeller. In other embodiments, the indoor fan 110 may comprise a mixed-flow fan and/or any other suitable type of fan. The indoor fan 110 is configured as a modulating and/or variable speed fan capable of being operated at many speeds over one or more ranges of speeds. In other embodiments, the indoor fan 110 may be configured as a multiple speed fan capable of being operated at a plurality of operating speeds by selectively electrically powering different ones of multiple electromagnetic windings of a motor of the indoor fan 110. In yet other embodiments, the indoor fan 110 may be a single speed fan.

The indoor metering device 112 is an electronically controlled motor driven electronic expansion valve (EEV). In alternative embodiments, the indoor metering device 112 may comprise a thermostatic expansion valve, a capillary tube assembly, and/or any other suitable metering device. The indoor metering device 112 may comprise and/or be associated with a refrigerant check valve and/or refrigerant bypass for use when a direction of refrigerant flow through the indoor metering device 112 is such that the indoor metering device 112 is not intended to meter or otherwise substantially restrict flow of the refrigerant through the indoor metering device 112.

Outdoor unit 104 comprises an outdoor heat exchanger 114, a compressor 116, an outdoor fan 118, an outdoor metering device 120, and a reversing valve 122. Outdoor heat exchanger 114 is a spine fin heat exchanger configured to allow heat exchange between refrigerant carried within internal passages of the outdoor heat exchanger 114 and fluids that contact the outdoor heat exchanger 114 but that are kept segregated from the refrigerant. In other embodiments, outdoor heat exchanger 114 may comprise a plate fin heat exchanger, a microchannel heat exchanger, or any other suitable type of heat exchanger.

The compressor 116 is a multiple speed scroll type compressor configured to selectively pump refrigerant at a plurality of mass flow rates. In alternative embodiments, the compressor 116 may comprise a modulating compressor capable of operation over one or more speed ranges, the compressor 116 may comprise a reciprocating type compressor, the compressor 116 may be a single speed compressor, and/or the compressor 116 may comprise any other suitable refrigerant compressor and/or refrigerant pump.

The outdoor fan 118 is an axial fan comprising a fan blade assembly and fan motor configured to selectively rotate the fan blade assembly. In other embodiments, the outdoor fan 118 may comprise a mixed-flow fan, a centrifugal blower, and/or any other suitable type of fan and/or blower. The outdoor fan 118 is configured as a modulating and/or variable speed fan capable of being operated at many speeds over one or more ranges of speeds. In other embodiments, the outdoor fan 118 may be configured as a multiple speed fan capable of being operated at a plurality of operating speeds by selectively electrically powering different ones of multiple electromagnetic windings of a motor of the outdoor fan 118. In yet other embodiments, the outdoor fan 118 may be a single speed fan.

The outdoor metering device 120 is a thermostatic expansion valve. In alternative embodiments, the outdoor metering device 120 may comprise an electronically controlled motor driven EEV, a capillary tube assembly, and/or any other suitable metering device. The outdoor metering device 120 may comprise and/or be associated with a refrigerant check valve and/or refrigerant bypass for use when a direction of refrigerant flow through the outdoor metering device 120 is such that the outdoor metering device 120 is not intended to meter or otherwise substantially restrict flow of the refrigerant through the outdoor metering device 120.

The reversing valve 122 is a so-called four-way reversing valve. The reversing valve 122 may be selectively controlled to alter a flow path of refrigerant in the HVAC system 100 as described in greater detail below. The reversing valve 122 may comprise an electrical solenoid or other device configured to selectively move a component of the reversing valve 122 between operational positions.

The system controller 106 may comprise a touchscreen interface for displaying information and for receiving user inputs. The system controller 106 may display information related to the operation of the HVAC system 100 and may receive user inputs related to operation of the HVAC system 100. However, the system controller 106 may further be operable to display information and receive user inputs tangentially and/or unrelated to operation of the HVAC system 100. In some embodiments, the system controller 106 may comprise a temperature sensor and may further be configured to control heating and/or cooling of zones associated with the HVAC system 100. In some embodiments, the system controller 106 may be configured as a thermostat for controlling supply of conditioned air to zones associated with the HVAC system.

In some embodiments, the system controller 106 may selectively communicate with an indoor controller 124 of the indoor unit 102, with an outdoor controller 126 of the outdoor unit 104, and/or with other components of the HVAC system 100. In some embodiments, the system controller 106 may be configured for selective bidirectional communication over a communication bus 128. In some embodiments, portions of the communication bus 128 may comprise a three-wire connection suitable for communicating messages between the system controller 106 and one or more of the HVAC system 100 components configured for interfacing with the communication bus 128. Still further, the system controller 106 may be configured to selectively communicate with HVAC system 100 components and/or other device 130 via a communication network 132. In some embodiments, the communication network 132 may comprise a telephone network and the other device 130 may comprise a telephone. In some embodiments, the communication network 132 may comprise the Internet and the other device 130 may comprise a so-called smartphone and/or other Internet enabled mobile telecommunication device.

The indoor controller 124 may be carried by the indoor unit 102 and may be configured to receive information inputs, transmit information outputs, and otherwise communicate with the system controller 106, the outdoor controller 126, and/or any other device via the communication bus 128 and/or any other suitable medium of communication. In some embodiments, the indoor controller 124 may be configured to communicate with an indoor personality module 134, receive information related to a speed of the indoor fan 110, transmit a control output to an electric heat relay, transmit information regarding an indoor fan 110 volumetric flow-rate, communicate with and/or otherwise affect control over an air cleaner 136, and communicate with an indoor EEV controller 138. In some embodiments, the indoor controller 124 may be configured to communicate with an indoor fan controller 142 and/or otherwise affect control over operation of the indoor fan 110. In some embodiments, the indoor personality module 134 may comprise information related to the identification and/or operation of the indoor unit 102 and/or a position of the outdoor metering device 120.

In some embodiments, the indoor EEV controller 138 may be configured to receive information regarding temperatures and/or pressures of the refrigerant in the indoor unit 102. More specifically, the indoor EEV controller 138 may be configured to receive information regarding temperatures and pressures of refrigerant entering, exiting, and/or within the indoor heat exchanger 108. Further, the indoor EEV controller 138 may be configured to communicate with the indoor metering device 112 and/or otherwise affect control over the indoor metering device 112.

The outdoor controller 126 may be carried by the outdoor unit 104 and may be configured to receive information inputs, transmit information outputs, and otherwise communicate with the system controller 106, the indoor controller 124, and/or any other device via the communication bus 128 and/or any other suitable medium of communication. In some embodiments, the outdoor controller 126 may be configured to communicate with an outdoor personality module 140 that may comprise information related to the identification and/or operation of the outdoor unit 104. In some embodiments, the outdoor controller 126 may be configured to receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116. In some embodiments, the outdoor controller 126 may be configured to transmit information related to monitoring, communicating with, and/or otherwise affecting control over the outdoor fan 118, a compressor sump heater, a solenoid of the reversing valve 122, a relay associated with adjusting and/or monitoring a refrigerant charge of the HVAC system 100, a position of the indoor metering device 112, and/or a position of the outdoor metering device 120. The outdoor controller 126 may further be configured to communicate with a compressor drive controller 144 that is configured to electrically power and/or control the compressor 116.

The HVAC system 100 is shown configured for operating in a so-called cooling mode in which heat is absorbed by refrigerant at the indoor heat exchanger 108 and heat is rejected from the refrigerant at the outdoor heat exchanger 114. In some embodiments, the compressor 116 may be operated to compress refrigerant and pump the relatively high temperature and high pressure compressed refrigerant from the compressor 116 to the outdoor heat exchanger 114 through the reversing valve 122 and to the outdoor heat exchanger 114. As the refrigerant is passed through the outdoor heat exchanger 114, the outdoor fan 118 may be operated to move air into contact with the outdoor heat exchanger 114, thereby transferring heat from the refrigerant to the air surrounding the outdoor heat exchanger 114. The refrigerant may primarily comprise liquid phase refrigerant and the refrigerant may flow from the outdoor heat exchanger 114 to the indoor metering device 112 through and/or around the outdoor metering device 120 which does not substantially impede flow of the refrigerant in the cooling mode. The indoor metering device 112 may meter passage of the refrigerant through the indoor metering device 112 so that the refrigerant downstream of the indoor metering device 112 is at a lower pressure than the refrigerant upstream of the indoor metering device 112. The pressure differential across the indoor metering device 112 allows the refrigerant downstream of the indoor metering device 112 to expand and/or at least partially convert to a two-phase (vapor and gas) mixture. The two phase refrigerant may enter the indoor heat exchanger 108. As the refrigerant is passed through the indoor heat exchanger 108, the indoor fan 110 may be operated to move air into contact with the indoor heat exchanger 108, thereby transferring heat to the refrigerant from the air surrounding the indoor heat exchanger 108, causing evaporation of the liquid portion of the two phase mixture. The refrigerant may thereafter re-enter the compressor 116 after passing through the reversing valve 122.

To operate the HVAC system 100 in the so-called heating mode, the reversing valve 122 may be controlled to alter the flow path of the refrigerant, the indoor metering device 112 may be disabled and/or bypassed, and the outdoor metering device 120 may be enabled. In the heating mode, refrigerant may flow from the compressor 116 to the indoor heat exchanger 108 through the reversing valve 122, the refrigerant may be substantially unaffected by the indoor metering device 112, the refrigerant may experience a pressure differential across the outdoor metering device 120, the refrigerant may pass through the outdoor heat exchanger 114, and the refrigerant may reenter the compressor 116 after passing through the reversing valve 122. Most generally, operation of the HVAC system 100 in the heating mode reverses the roles of the indoor heat exchanger 108 and the outdoor heat exchanger 114 as compared to their operation in the cooling mode.

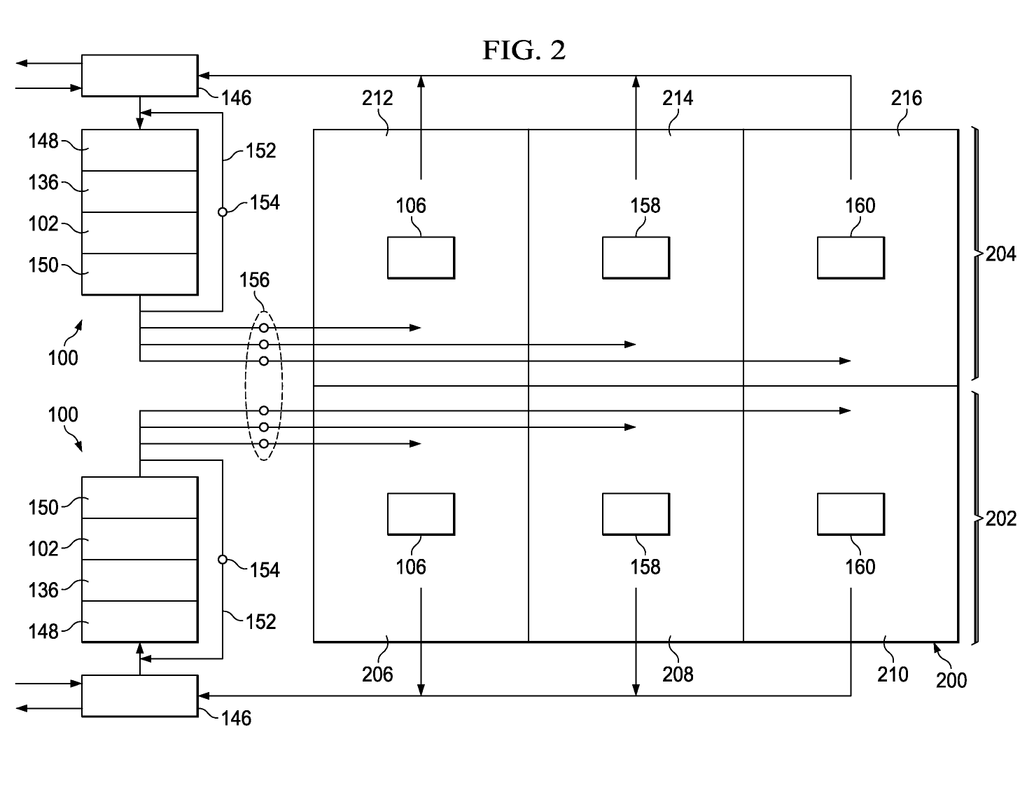

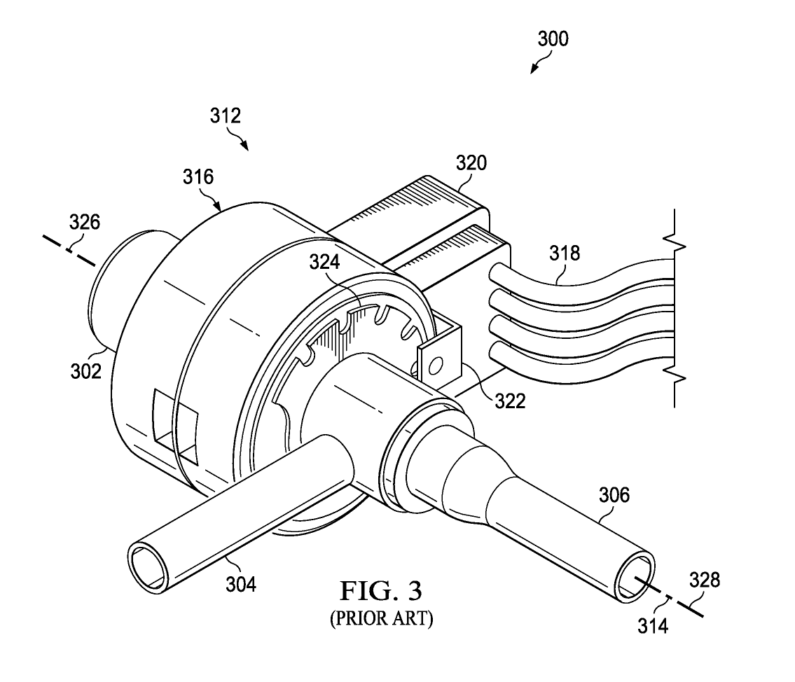

Referring now to FIG. 2, a simplified schematic diagram of the air circulation paths for a structure 200 conditioned by two HVAC systems 100 is shown. In this embodiment, the structure 200 is conceptualized as comprising a lower floor 202 and an upper floor 204. The lower floor 202 comprises zones 206, 208, and 210 while the upper floor 204 comprises zones 212, 214, and 216. The HVAC system 100 associated with the lower floor 202 is configured to circulate and/or condition air of lower zones 206, 208, and 210 while the HVAC system 100 associated with the upper floor 204 is configured to circulate and/or condition air of upper zones 212, 214, and 216.

In addition to the components of HVAC system 100 described above, in this embodiment, each HVAC system 100 further comprises a ventilator 146, a prefilter 148, a humidifier 150, and a bypass duct 152. The ventilator 146 may be operated to selectively exhaust circulating air to the environment and/or introduce environmental air into the circulating air. The prefilter 148 may generally comprise a filter media selected to catch and/or retain relatively large particulate matter prior to air exiting the prefilter 148 and entering the air cleaner 136. The humidifier 150 may be operated to adjust a humidity of the circulating air. The bypass duct 152 may be utilized to regulate air pressures within the ducts that form the circulating air flow paths. In some embodiments, air flow through the bypass duct 152 may be regulated by a bypass damper 154 while air flow delivered to the zones 206, 208, 210, 212, 214, and 216 may be regulated by zone dampers 156.

Still further, each HVAC system 100 may further comprise a zone thermostat 158 and a zone sensor 160. In some embodiments, a zone thermostat 158 may communicate with the system controller 106 and may allow a user to control a temperature, humidity, and/or other environmental setting for the zone in which the zone thermostat 158 is located. Further, the zone thermostat 158 may communicate with the system controller 106 to provide temperature, humidity, and/or other environmental feedback regarding the zone in which the zone thermostat 158 is located. In some embodiments, a zone sensor 160 may communicate with the system controller 106 to provide temperature, humidity, and/or other environmental feedback regarding the zone in which the zone sensor 160 is located.

While HVAC systems 100 are shown as a so-called split system comprising an indoor unit 102 located separately from the outdoor unit 104, alternative embodiments of an HVAC system 100 may comprise a so-called package system in which one or more of the components of the indoor unit 102 and one or more of the components of the outdoor unit 104 are carried together in a common housing or package. The HVAC system 100 is shown as a so-called ducted system where the indoor unit 102 is located remote from the conditioned zones, thereby requiring air ducts to route the circulating air. However, in alternative embodiments, an HVAC system 100 may be configured as a non-ducted system in which the indoor unit 102 and/or multiple indoor units 102 associated with an outdoor unit 104 is located substantially in the space and/or zone to be conditioned by the respective indoor units 102, thereby not requiring air ducts to route the air conditioned by the indoor units 102.

Still referring to FIG. 2, the system controllers 106 may be configured for bidirectional communication with each other and may further be configured so that a user may, using any of the system controllers 106, monitor and/or control any of the HVAC system 100 components regardless of which zones the components may be associated. Further, each system controller 106, each zone thermostat 158, and each zone sensor 160 may comprise a humidity sensor. As such, it will be appreciated that structure 200 is equipped with a plurality of humidity sensors in a plurality of different locations. In some embodiments, a user may effectively select which of the plurality of humidity sensors is used to control operation of one or more of the HVAC systems 100.

Referring now to Prior Art FIGS. 3 and 4, oblique views of an EEV 300 and a coil assembly 316 of the EEV 300 according to an embodiment of the disclosure are shown, respectively. The EEV 300 comprises a valve body 302 comprising an interior space connected to a side tube 304 and an inline tube 306. The EEV 300 further comprises a selectively movable obturator that may be integrally connected to a movable rod within the interior space of the valve body 302. An electronically controlled motor 312 may be at least partially housed within the valve body 302 and may be configured to selectively move the metering device along an axis 314 that is substantially coaxial with the inline tube 306. The motor 312 may further comprise a coil assembly 316 configured to comprise and/or house motor windings and/or other structural components configured to selectively produce electromagnetic fields in response to passing an electrical current therethrough. In some embodiments, the motor windings and/or other structural components configured to selectively produce electromagnetic fields, collectively referred to as electromagnetic drivers 315, may be at least partially enveloped and/or captured within a coil housing 317 of the coil assembly 316. In some embodiments the coil housing 317 may comprise a shell configured to retain, envelope, and/or at least partially define the bounds of an internal annular space in which at least a portion of the electromagnetic drivers 315 may be located.

The coil housing 317 may comprise one or more so-called “stator bars” 319 located radially inward of the components housed in the internal annular space of the coil housing 317 and which may selectively contribute to the generation of the above-described electromagnetic fields. In some cases, the stator bars 319 may generally disposed in an angular array or otherwise disposed to contact and/or be slightly radially offset from the valve body 302. In some cases, some stator bars 319 may comprise a portion of the coil housing 317 while other stator bars 319 may extend from components housed in the internal annular space of the coil housing 317. In some cases, some stator bars 319 may be electrically driven while other stator bars 319 are passive components that may assist in maintaining an orientation of the coil assembly 316 relative to the valve body 302. The electrical currents may be supplied via control wiring 318 connected to a wiring harness 320 of the coil assembly 316. The coil assembly 316 may further comprise an orientation tab 322 configured to selectively interact with an orientation ring 324 that may be substantially fixed relative to the valve body 302.

Referring now to Prior Art FIG. 4, it is shown that the electromagnetic drivers 315 may be substantially encapsulated within an encapsulating ring 321 of material while still allowing the stator bars 319 of the electromagnetic drivers 315 to protrude radially inward and potentially into contact with the valve body 302. However, neither the stator bars 319 nor the coil housing 317 are encapsulated within an encapsulating material. Accordingly, the stator bars 319 and the coil housing 317 may be prone to oxidation. In some embodiments, one or more of the stator bars 319 and the coil housing 317 may comprise galvanized steel, such as, but not limited to, so-called G90 galvanized steel.

In some embodiments, the EEV 300 may be assembled by, first, aligning a central axis 326 of the coil assembly 316 with the axis 314 that may be substantially coaxial with a central axis 328 of the valve body 302. After aligning the axes 326, 328, the coil assembly 316 may be moved toward the valve body 302 to receive the valve body 302 through a central aperture 330 of the coil assembly 316. After sufficient movement of the coil assembly 316 relative to the valve body 302, the orientation tab 322 may be kept from locking with the orientation ring 324 as the coil assembly 316 is rotated about the central axis 326 until a desired angular orientation of the coil assembly 316 relative to the valve body 302 is achieved.

Referring now to Prior Art FIG. 5, an oblique view of another embodiment of a coil assembly 500 according to the disclosure is shown. Coil assembly 500 may be substantially similar to coil assembly 316. However, coil assembly 500 may further comprise a casing 502 generally configured to substantially encase substantially all of the components of coil assembly 500 but for the stator bars 319, which are left exposed. In some embodiments, the casing 502, such as at 502′, may extend radially inward toward the central axis 326 a distance less than the distance one or more of the stator bars 319 extend radially inward toward the central axis 326. In other embodiments, the casing, such as at 502′, may extend radially inward toward the central axis 326 a distance substantially equal to the distance one or more of the stator bars 319 extend radially inward toward the central axis 326 while not covering the stator bars 319.

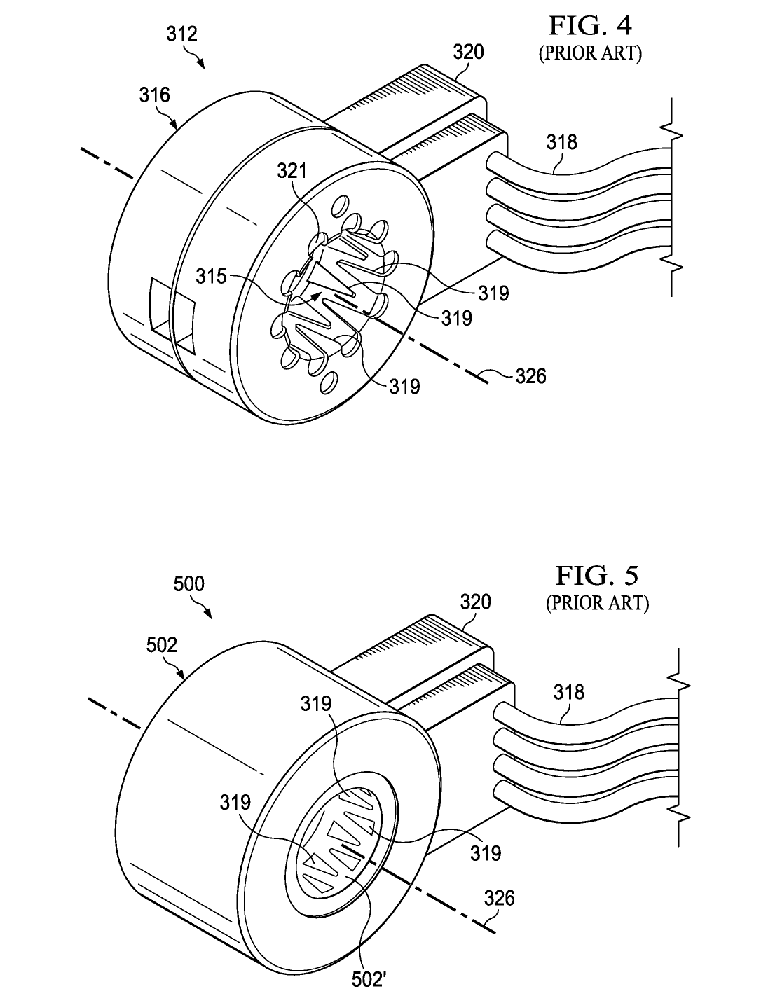

Referring now to FIG. 6, an oblique view of another embodiment of a coil assembly 600 according to the disclosure is shown. Coil assembly 600 may be substantially similar to coil assembly 500. However, coil assembly 600 may further comprise a casing 602 generally configured to substantially encase substantially all of the components of coil assembly 500, including the stator bars 319. In some embodiments, the casing 602, such as at 602′, may extend radially inward toward the central axis 326 a distance greater than the distance one or more of the stator bars 319 extend radially inward toward the central axis 326 while also extending over the stator bars 319. In some embodiments, the casing 602 may comprise a substantially constant inner diameter 604 along the longitudinal length of the casing 602. In other embodiments, the casing 602 may comprise a plurality of diameters along the longitudinal length of the casing 602. For example, in some embodiments, the inner diameter 604 may generally be larger near a longitudinal end of the casing 602 configured to initially receive the valve body 302 upon assembly of an EEV substantially similar to EEV 300. In some cases, the inner diameter 604 may comprise a gradually increasing or decreasing size along the longitudinal length of the casing 602. In some embodiments, the casing 602 may comprise PolyPhenylene Ether. In other embodiments, the casing 602 may comprise any a resin, plastic, ceramic, and/or rubber material, and/or any other material suitable for providing a fluid tight barrier between the stator bars 319 and the surrounding environment.

In some embodiments, the casing 602 that encases the stator bars 319 may be provided by injection molding, casting, and/or any other suitable form of encapsulation. In some embodiments, the encapsulation of the stator bars 319 within the casing 602 may comprise the integral formation of the portion of the casing 602 that encapsulates the stator bars 319 with portions of the casing 602 that encase other components, such as the coil housing 317, so that a substantially unitary casing 602 is provided. In alternative embodiments, a coil assembly 600 may be constructed by providing a coil assembly substantially similar to coil assembly 500, inserting a sleeve of fluid barrier material into the central aperture of the coil assembly 500 so that the fluid barrier material is disposed between the stator bars 319 and the central axis 326, and thereafter sealing the ends of the sleeve to casing 502 so that a fluid tight barrier is provided between the stator bars 319 and the surrounding environment. Such sealing may comprise, melting, adhering, interference fitting, and/or any other suitable method of providing a fluid tight seal. In some embodiments, the fluid barrier material may comprise the same material as the casing 502 while in other embodiments the materials may be different from each other. In some embodiments, exposed stators 319 of a coil assembly may be radially shortened so that an EEV assembly such as EEV 300 may accommodate the addition of material between the stators 319 and the valve body 302 without the need for changing the external dimensions of the valve body 302. In some cases where addition of a fluid tight barrier between the stator bars 319 and the surrounding environment may negatively impact performance of the EEV, an operational property of the electricity supplied to the EEV may be altered to increase or decrease an electromagnetic field, such as, but not limited to, an alteration in electrical current magnitude.

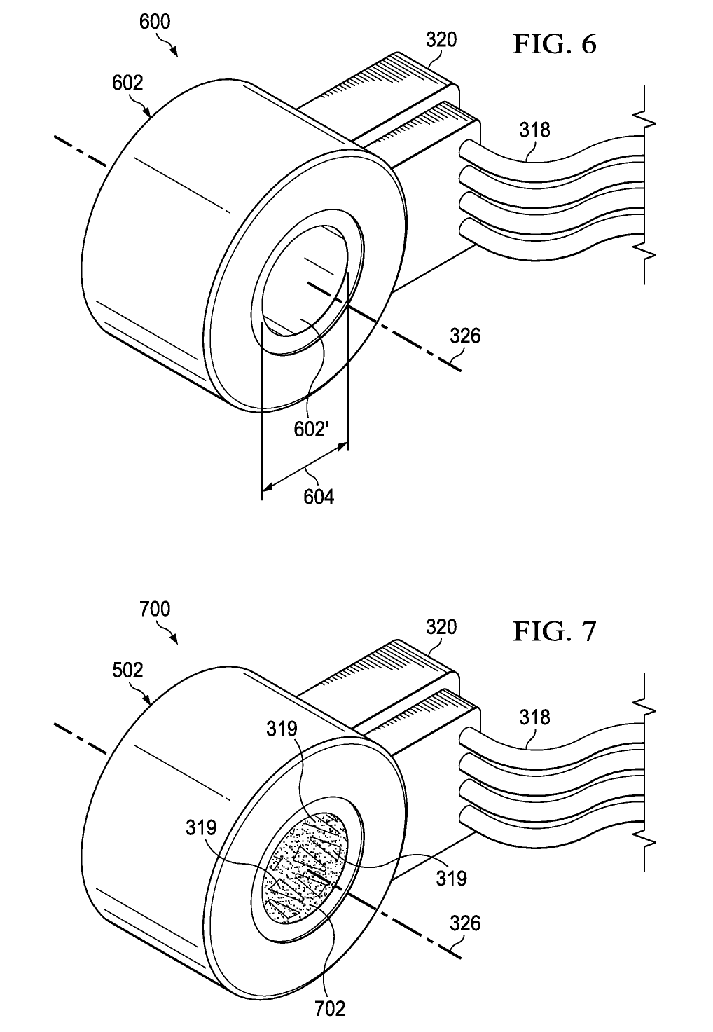

Referring now to FIG. 7, an oblique view of another embodiment of a coil assembly 700 according to the disclosure is shown. Coil assembly 700 may be substantially similar to coil assembly 500. However, coil assembly 700 may further comprise a coating 702 generally configured to substantially cover all of the stator bars 319 that, without the coating 702, may otherwise be exposed to the surrounding environment. In some embodiments, one or more of the stator bars 319 may be coated individually so that a plurality of patches of coating 702 are applied to the coil assembly 700. In other embodiments, a single continuous patch of coating 702 may cover a plurality and/or all of the stator bars 319. In some embodiments, the coating 702 may comprise a phenolic material. In other embodiments, the coating 702 may comprise any a resin, plastic, ceramic, and/or rubber material, and/or any other material suitable for providing a fluid tight barrier between the stator bars 319 and the surrounding environment. In some embodiments, the coating 702 may be applied to the stator bars 319 prior to substantially encasing the electromagnetic drivers 315. In other embodiments, the coating 702 may be applied to stator bars 319 already substantially encased but left exposed to the surrounding environment.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. An HVAC system, comprising:
an electronic expansion valve, comprising:
a valve body comprising a first motor component;
a coil assembly comprising a plurality of stator bars, the plurality of stator bars being sealed from a surrounding environment by at least one fluid tight barrier at least partially disposed between the valve body and the plurality of stator bars.

2. The HVAC system of claim 1, wherein the stator bars comprise galvanized steel.

3. The HVAC system of claim 1, wherein the fluid tight barrier comprises PolyPhenylene Ether.

4. The HVAC system of claim 1, wherein the fluid tight barrier comprises a phenol material.

5. The HVAC system of claim 1, the at least one fluid tight barrier comprises a plurality of patches of a coating.

6. The HVAC system of claim 1, wherein the fluid tight barrier comprises a substantially constant diameter along a length of the coil assembly.

7. The HVAC system of claim 1, wherein the fluid tight barrier comprises a material different than another material that contacts the plurality of stator bars.

8. The HVAC system of claim 1, wherein the plurality of stator bars are entirely encased within the fluid tight barrier.

9. The HVAC system of claim 1, wherein the fluid tight barrier is configured to reduce oxidation of the plurality of stator bars as a result of exposure to air of a surrounding environment.

10. The HVAC system of claim 1, wherein the HVAC system comprises a heat pump system and a plurality of the electronic expansion valves.

11. An electronically controlled expansion valve, comprising:
a generally cylindrical valve body comprising a valve body central axis;
a generally annular coil assembly comprising a coil assembly central axis, the coil assembly being configured to selectively receive at least a portion of the valve body though an aperture of the coil assembly when the valve body central axis and the coil assembly central axis are substantially coaxially aligned with each other, the coil assembly comprising a plurality of electromagnetic drivers that extend radially inward toward the valve body, and a fluid tight barrier at least partially disposed radially between the plurality of electromagnetic drivers and the valve body.

12. The valve of claim 11, wherein the electromagnetic drivers comprise at least one stator bar.

13. The valve of claim 11, wherein the aperture of the coil comprises a substantially constant diameter.

14. The valve of claim 11, wherein the electromagnetic drivers are substantially encased within the fluid tight barrier.

15. The valve of claim 11, wherein at least a portion of the fluid tight barrier contacts the valve body.

16. A method of constructing an electronically controlled expansion valve, comprising:
providing a coil assembly comprising a plurality of stator bars; and
sealing the plurality of stator bars from a surrounding environment.

17. The method of claim 16, further comprising:
receiving a valve body into an aperture of the coil assembly.

18. The method of claim 16, further comprising:
substantially entirely encasing the plurality of stator bars within a fluid tight barrier.

19. The method of claim 16, further comprising:
applying plurality of separate coating patches to seal the plurality of stator bars from the surrounding environment.

20. The method of claim 16, wherein the plurality of stator bars comprise galvanized steel and wherein the plurality of stator bars are sealed from the surrounding environment using PolyPhenylene Ether.
